(19) United States
(12) Patent Application Publication
(10) Pub. No.: US 2008/0318821 A1
(43) Pub. Date: Dec. 25, 2008

(54) Dust-reduced Micronized wax mixtures comprising Polyethylene Glycol (PEG) compounds

(75) Inventors: Anja Heinze, Hochheim/Main (DE); Ernst Krendlinger, Friedberg (DE); Michael Wernicke, Kaiseraugst (CH)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/214,752

(22) Filed: Jun. 20, 2008

(30) Foreign Application Priority Data
Jun. 20, 2007 (DE) 10 2007 028 308.5

(51) Int. Cl. C10M 133/00; C09D 191/06; C10M 105/00

(52) U.S. Cl. 508/545; 106/270; 524/186; 524/612; 508/110

(57) ABSTRACT

Wax mixture with reduced dust formation, comprising two or more components A, B, C and/or D, component A acting as an auxiliary and comprising one or more polyethylene glycols or polyethylene glycol derivatives, and component B standing for one or more amide waxes, component C for one or more hydrocarbon waxes, and component D for one or more oxidized long-chain hydrocarbon waxes.

The present invention is described in the German priority application No. 102007028308.5, filed Jun. 20, 2007, which is hereby incorporated by reference as is fully disclosed herein.

The invention relates to mixtures of finely ground waxes comprising two or more components A, B, C and/or D and exhibiting reduced dust formation.

The use of waxes as processing assistants for plastics, for dispersing pigments in plastics, as additives to printing inks and coating materials, as processing assistants for powder coating materials, and in a range of further applications, is known. These applications often require waxes in ground form, permitting lower-energy and hence more economic processing, enhanced dispersion, and lower levels of addition. Products of this kind are known that are based on hydrocarbons or amide waxes. They are readily grindable and for different applications are also combined with other products, such as PTFE powders.

With apolar media such as aliphatic or aromatic solvents, polyethylene, polypropylene, and other apolar compounds, the compatibility of these apolar waxes is very good. More and more, however, finely ground waxes are desired for polar systems as well, since apolar waxes can be used here only in some cases, since there are often instances of incompatibility.

For this purpose it is possible alternatively to use oxidized hydrocarbon waxes or natural polar waxes and their derivatives, such as montan wax acid derivatives.

Products of this kind are known, such as Ceridust® 3715 or Ceridust® 5551 from Clariant Produkte (Deutschland) GmbH, for example. Their application is restricted, however, owing to the low grinding yield and the associated lack of economy. Wax powders can be produced, alternatively, by spray drying; in that case, however, there may be restrictions in terms of thermal durability and viscosity and also in terms of the combination of different waxes and/or wax powders.

On the basis of the known grinding techniques and the ultrafine powders produced using them, a disadvantage effecting production and user processing is the explosion hazard due to dusts that form, a disadvantage which can be avoided by means of the wax formulations of the invention.

The problem addressed is that of providing wax mixtures which can be added to the grinding operation during production without adversely affecting the economy of the operation or the properties of the end product, and at the same time minimizing the formation of dust during production and/or processing, a task which the existing, state-of-the-art products are unable to accomplish.

Surprisingly it has been found that through the addition of wax mixtures comprising polyethylene glycol or its derivatives to the wax components for grinding it is possible to minimize the formation of dusts during the production and/or processing of the finely ground wax products.

The present invention accordingly provides wax mixtures with reduced dust formation, comprising two or more components A, B, C and/or D, component A acting as an auxiliary and comprising one or more polyethylene glycols or polyethylene glycol derivatives. Amide waxes can be used as component B, hydrocarbon waxes as component C, and oxidized long-chain hydrocarbon waxes as component D.

The polyethylene glycol preferably comprises polyethylene glycols having a dihydroxy functionalization and an average molecular weight Mw of 2700 to 45 000 g/mol, preferably 5000 to 40 000 g/mol, more preferably 8000 to 35 000 g/mol.

Examples of polyethylene glycols which can be used with preference in accordance with the invention are as follows: polyethylene glycol 10000 S flakes, polyethylene glycol 12000 S flakes, polyethylene glycol 20000 S flakes or polyethylene glycol 35000 S flakes.

The chemical synthesis of the polyethylene glycols (PEG) which can be used in accordance with the invention is easy to represent starting from the simple glycols. Glycols are dihydric primary alcohols which therefore contain two hydroxyl groups (OH groups) in the molecule.

The base compound on which all ethylene glycols are based is the reactive ethylene oxide, which is obtained by direct catalytic oxidation from ethylene and oxygen.

CH₂═CH₂+½O₂→CH₂CH₂O

Ethylene oxide is a compound which, with ring opening, easily forms addition chains in which there is a continual repetition of the —CH₂CH₂O— members.

With water, ethylene oxide forms monoethylene glycol. Further additions of ethylene oxide give rise to the subsequent members of the ethylene glycol series (diethylene glycol, triethylene glycol). The numerous subsequent members of the homologous series (tetra-, penta-, hexaethylene glycol, etc.) are called polyethylene glycols (PEG). The general empirical formula of the PEG is as follows:

H(OCH₂CH₂)ₙOH,

where the number n denotes the total number of ethylene oxide groups participating in the construction of the molecule, and is termed the degree of polymerization.

PEG, like all high-polymer substances, are not entirely uniform chemical compounds, but instead are mixtures of polymer homology resembling one another very closely. A characteristic of particular PEG types is their average molecular weight Mw, which is given by the hydroxyl number, which can be determined analytically in each case.

As component B it is preferred to use amide waxes, in the form, for example, of reaction products of ammonia and long-chain fatty acids or hydroxy-fatty acids and/or their mixtures.

The amide waxes are preferably reaction products of long-chain amines such as, for example, hydrogenated tallow amine, stearylamine, palmitylamine, cocoamine and long-chain fatty acids or hydroxy-fatty acids and/or their mixtures.

As component C the invention uses hydrocarbon waxes, more particularly polyethylene waxes.

As component D it uses oxidized long-chain hydrocarbon waxes, preferably oxidized polyethylene waxes.

With particular preference components C and D are polyethylene waxes, more particularly waxes prepared by the Ziegler process and/or by means of metallocene technology.

In another preferred embodiment components C and D are Fischer-Tropsch waxes.

In general it is also possible to use ester waxes as components B to D.

Besides waxes of all kinds, plastics as well can be ground with PEG in order to reduce the formation of dust.

The wax mixture of the invention preferably comprises the components in the following proportions:
1 % to 5%, preferably 1 % to 4%, more particularly 1 % to 3% by weight of component A
0% to 99%, preferably 10% to 98%, more particularly 40% to 97% by weight of component B
0% to 99%, preferably 20% to 98%, more particularly 50% to 97% by weight of component C
0% to 99%, preferably 10% to 98%, more particularly 20% to 97% by weight of component D
the sum of the components being 100% by weight.

The invention also provides for the use of wax mixtures of the invention as additives in coating materials, powder coating materials, and printing inks, and also for dispersing pigments and additives in plastics, as water repellency additives in crop protection products, or as lubricants in plastics, such as in PVC, PP, PE, PA, for example, and other thermoplastics.

The wax mixtures of the invention contribute to improved processing in the stated applications, such as the metering of the wax mixtures, for example. Furthermore, the wax mixtures of the invention are distinguished by a reduction in dust formation, which is important especially in the case of sectors requiring dust explosion labeling

and which therefore leads to considerable cost reductions, more particularly in terms of capital investment.

### EXAMPLES

Production of wax mixtures with polyethylene glycol raw-material component. Grinding was carried out using an AFG 100 fluid-bed opposed-jet mill from Hosokawa Alpine. The target size for the particles was a d₅₀ of 5 to 10 μm. The particle size was measured by the laser diffraction method with the LA 920 instrument from Horiba.

| | | Example 1 | Example 2 | Example 3 |
|---|---|---|---|---|
| Component | Compound | (comparative) | (invention) | (invention) |
| A | Assistant, | — | 1 | 3 |
| | PEG | | | |
| B | Amide wax | 50 | 49.5 | 48.5 |
| C | Polyethylene | 50 | 49.5 | 48.5 |
| | wax | | | |
| D | Oxidized | — | — | — |
| | polyethylene | | | |
| | wax | | | |

| | | Example 4 | Example 5 | Example 6 |
|---|---|---|---|---|
| Component | Compound | (comparative) | (inventive) | (inventive) |
| A | Assistant, PEG | — | 1 | 3 |
| B | Amide wax | — | — | — |
| C | Polyethylene | 80 | 79.5 | 78.5 |
| | wax | | | |
| D | Oxidized | 20 | 19.5 | 18.5 |
| | polyethylene | | | |
| | wax | | | |

Raw Materials for Grinding

| | |
|---|---|
| Polyethylene glycol assistant - | PEG ® 35000 S |
| Amide wax - | Licowax ® C |
| Polyethylene wax - | Licocene ® PE 4201 |
| Oxidized polyethylene wax - | Licocene ® PE OX 4241 |

All products are products from Clariant Produkte (Deutschland) GmbH.

The wax mixtures from the grinding tests were subjected to dust measurement. This was done using an automatic dust measuring instrument consisting of a measuring box with insert (light source and photocell from Dr. B. Lange), 50 cm drop tube, reservoir tube with filling funnel and magnetic valve, and a measuring device. The method is based on DIN 55992-2.

The parameters determined were the dust index in [%] and the dust value in [%]. The dust value is calculated from the difference between the dust index [%] and the maximum value [%] displayed on the instrument.

| Example | Dust index [%] | Max. value [%] | Dust value [%] |
|---|---|---|---|
| 1 | 109.9 | 74.7 | 35.2 |
| 2 | 104.6 | 76.3 | 28.3 |
| 3 | 101.6 | 79.4 | 22.2 |
| 4 | 12.5 | 8.8 | 3.7 |
| 5 | 11.1 | 8.6 | 2.5 |
| 6 | 9.8 | 8.3 | 1.5 |

Use Examples

Use in Coating Material

In order to be able to ensure that the performance properties of these wax mixtures are not detrimentally affected by the addition of component A (in this case PEG 35000 S), the mixtures were tested in a 2-component polyurethane varnish.

Formula of 2-Component Polyurethane Varnish

| | % by weight |
|---|---|
| Component 1 | |
| Desmophen 1300/75% in xylene (Bayer) | 32.0 |
| Walsroder Nitrocellulose E 510 in 20% ESO | 1.5 |
| (Wolff Cellulosics) | |
| Acronal 4 L 10% in ethyl acetate (BASF) | 0.2 |
| Baysilone OL 17 10% in xylene (Borchers) | 0.2 |
| Ethyl acetate (technical grade) | 10.4 |
| Butyl acetate (technical grade) | 11.0 |
| Methoxypropyl acetate (technical grade) | 10.8 |
| Xylene (technical grade) | 8.9 |
| | 75.0 |
| Component 2 | |
| Desmodur IL (Bayer) | 14.2 |
| Desmodur L 75 (Bayer) | 9.4 |
| Xylene (technical grade) | 1.4 |
| | 25.0 |

Use was made of 2% and 4% of the wax mixtures from the examples, based on the overall varnish.

Waxes are known to influence the following properties in varnish: matting, improving the scratch resistance (mar resistance), slip (slip resistance) or antislip quality, and many others.

Gloss Measurement

The varnishes were knife-coated with wet-film thicknesses of 60 μm onto glass plates using frame-type coaters and were subjected to measurement at an incident angle of 60° using the Micro-Tri-Glossμ (from BYK-Gardner).

Gloss at 60°

| Example | 2% | 4% |
|---|---|---|
| 1 | 86 | 47 |
| 2 | 82 | 46 |
| 3 | 85 | 50 |
| 4 | 88 | 48 |
| 5 | 83 | 45 |
| 6 | 85 | 48 |

Determination of the Mar Resistance

The varnishes were knife-coated with wet-film thicknesses of 60 μm onto glass plates using frame-type coaters, and the mar resistance was measured using the ZST 2095 mar resistance tester from Zehntner. A steel test disk and the 0-3 N pressure spring were used.

Figure in
newtons

| Example | 2% | 4% |
|---|---|---|
| 1 | 1.1 | 1.7 |
| 2 | 0.9 | 1.6 |
| 3 | 1.0 | 1.6 |
| 4 | 0.8 | 1.5 |
| 5 | 0.9 | 1.6 |
| 6 | 0.8 | 1.4 |

Determination of the Sliding Friction

The varnishes were knife-coated with wet-film thicknesses of 60 μm onto glass plates using frame-type coaters, and the coefficient of sliding friction was determined using the friction/peel tester. A weight with a leather sole (349 g) was selected as the tensioning weight.

Coefficient of
sliding friction

| Example | 2% | 4% |
|---|---|---|
| 1 | 0.46 | 0.40 |
| 2 | 0.45 | 0.39 |
| 3 | 0.44 | 0.40 |
| 4 | 0.42 | 0.36 |
| 5 | 0.42 | 0.36 |
| 6 | 0.43 | 0.39 |

It was demonstrated that, through the use of PEG as a dust reduction assistant, the technical properties of the varnish remain unaffected or are even slightly improved.

1. A wax mixture with reduced dust formation, comprising two or more components selected from the group consisting of A, B, C and D, component A acting as an auxiliary and comprising one or more polyethylene glycols or polyethylene glycol derivatives, wherein component B is one or more amide waxes, component C is one or more hydrocarbon waxes, and component D is one or more oxidized long-chain hydrocarbon waxes.

2. The wax mixture as claimed in claim 1, wherein component A comprises polyethylene glycols or derivatives thereof having an average molecular weight Mw of 2700 to 45 000 g/mol.

3. The wax mixture as claimed in claim 1, wherein the one or more amide waxes are reaction products of ammonia and long-chain fatty acids, hydroxy-fatty acids or a mixture thereof.

4. The wax mixture as claimed in claim 1, wherein the one or more amide waxes are reaction products of long-chain amines long-chain fatty acids, hydroxy-fatty acids or a mixture thereof.

5. The wax mixture as claimed in claim 1, wherein the one or more hydrocarbon waxes of component C and the one or more oxidized long-chain hydrocarbon waxes are polyethylene waxes.

6. The wax mixture as claimed in claim 1, wherein components C and D are polyethylene waxes prepared by the Ziegler process, by metallocene technology or a mixture thereof.

7. The wax mixture as claimed in claim 1, wherein components C and D are selected from polyethylene waxes prepared via the Fischer-Tropsch synthesis.

8. The wax mixture as claimed in claim 1, comprising the individual components in the following proportions:
1% to 5% by weight of component A
0% to 99% by weight of component B
0% to 99% by weight of component C
0% to 99% by weight of component D,
the sum of the components being 100% by weight.

9. The wax mixture as claimed in claim 1, wherein components A to D are in finely divided form.

10. The wax mixture as claimed in claim 1, wherein components A to D are used in a particle size of 5 to 18 μm.

11. An additive in coating materials, powder coating materials or printing inks, as a scratch protection, scuff protection, matting, devolatilizing or flow-control agent or as a slip additive comprising the wax mixture as claimed in claim 1.

12. A dispersing agent for dispersing pigments and additives in plastics comprising a wax mixture as claimed in claim 1.

13. A water repellency additive for crop protection products comprising a wax mixture as claimed in claim 1.

14. A lubricant for plastics comprising a wax mixture as claimed in claim 1.

15. The wax mixture as claimed in 4, wherein the reaction products of long-chain amines are hydrogenated tallowamine, stearylamine or palmitylamine, cocoamine.

16. The lubricant for plastics as claimed in claim 14, wherein the plastic is selected from the group consisting of PVC, PP, PE and PA.
